(19) United States
(12) Patent Application Publication
(10) Pub. No.: US 2016/0063438 A1
(43) Pub. Date: Mar. 3, 2016

(54) Methods and Systems for Consolidating Shipments of Multiple Products to Consumers

(71) Applicant: MASTERCARD INTERNATIONAL INCORPORATED, Purchase, NY (US)

(72) Inventors: Randall K. Shuken, Westport, CT (US); Debashis Ghosh, Charlotte, NC (US); Sebastian Shuken, Westport, CT (US)

(21) Appl. No.: 14/468,459

(22) Filed: Aug. 26, 2014

(51) Int. Cl. G06Q 10/08

(52) U.S. Cl. CPC G06Q 10/08355

(57) ABSTRACT

Methods and systems are provided for consolidating a shipment of purchased products to a consumer. A consumer is initially registered to a consolidation account for consolidated shipping of the products. The consolidation account typically includes at least one predefined shipping criteria, used to determine when to ship the consolidated products. Upon purchasing various products from one or more merchants, the products are associated, at a computing device, with the consumer's consolidation account and are routed to a hold location. Then, at the hold location, the products are pooled together and, when the at least one predefined shipping criteria is achieved, the products are routed, as a single shipment, to the consumer.

### FIELD

The present disclosure generally relates to methods and systems for consolidating shipments of multiple products to consumers.

### BACKGROUND

This section provides background information related to the present disclosure which is not necessarily prior art.

Products can be purchased by consumers from merchants in a variety of different ways. When products are purchased through websites associated with the merchants, the purchased products are often shipped directly to the consumers via carriers, such as UPS®, FedEx®, DHL®, etc. Typically, where consumers purchase multiple products, the consumers receive separate shipments of products, via one or more carriers, for each of the purchases.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure for consolidating shipments of products to consumers;

FIG. 2 is a block diagram of an exemplary computing device, that may be used in the system of FIG. 1;

FIG. 3 is an exemplary method for consolidating shipments of products to consumers; and

FIG. 4 is an exemplary interface suitable for use in the system of FIG. 1 and/or the method of FIG. 3, by a consumer, to direct a shipment of a purchased product to the consumer.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers often purchase products from merchants through websites or other means where the consumer is not present at the merchant. The products are then delivered to the consumers. When the consumers purchase products from multiple different merchants and/or purchase products from the same merchants at different times, the products are delivered to the consumers, via various carriers typically predetermined by the merchants, such as UPS®, FedEx®, DHL®, etc., in multiple different shipments, and at times convenient to the carriers. Further, the consumers typically receive no benefit or special treatment from the carriers, even when the same carriers are repeatedly used, as the product shipment/delivery relationships are typically driven by the merchants and not the consumers.

Methods and systems described herein permit multiple products to a consumer to be consolidated into a single shipment to the consumer. As can be appreciated, the single shipment of products facilitates fewer trips by the carriers to the consumer, potentially resulting in more efficient and/or reduced cost shipping. The consumer may further specify the particular carrier to be used for delivering the products, and may specify how and when the products are to be delivered, etc. It is contemplated that shipping costs may be reduced further through repeated use of a common carrier. Moreover, by specifying how and when the products are to be delivered, a level of convenience may be gained by the consumer. It is also contemplated that, through the methods and systems, the consumer may be able to negotiate directly with the selected carrier to coordinate the shipment and, in some cases, to also obtain discounts or other benefits in connection with the shipment (and future shipments). For example, the consumer may be able to compare different carriers, who may then compete for the business of consumer. Thus, the methods and systems offer a new way for the consumer to take control of delivery of the products, and get improved service from carriers and better pricing and value.

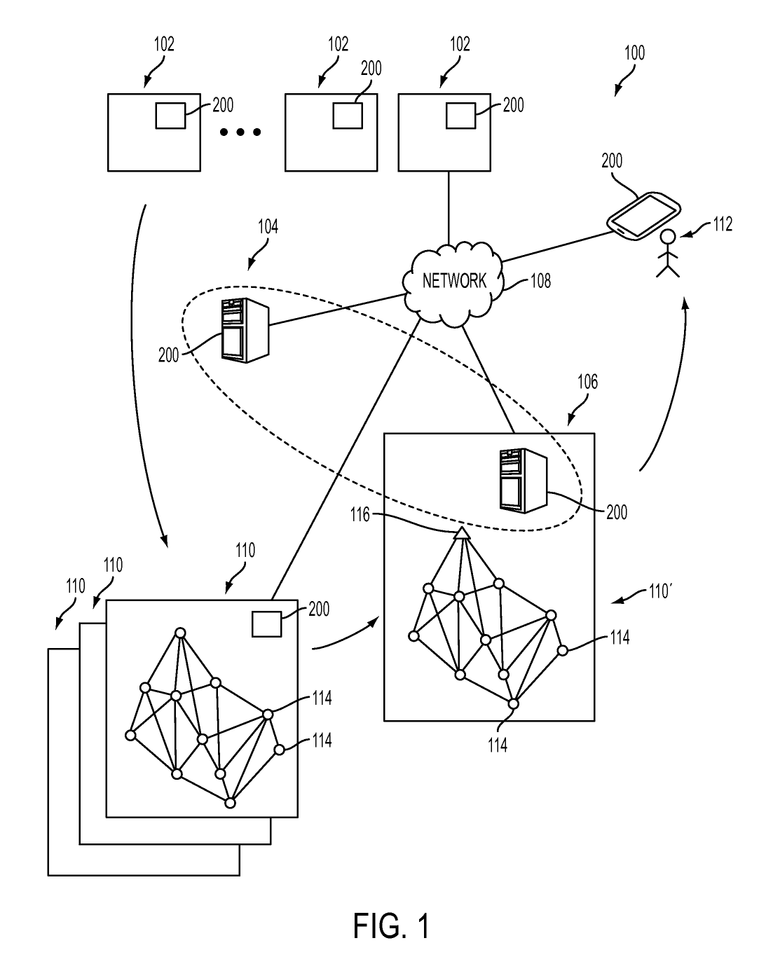

With reference now to the drawings, FIG. 1 illustrates an exemplary system 100, in which one or more aspects of the present disclosure may be implemented. Although components of the system 100 are presented in one arrangement, it should be appreciated that other exemplary embodiments may include the same or different components arranged otherwise, for example, depending on associations of consolidation managers, shipping managers, merchants, and carriers, etc.

The illustrated system 100 generally includes multiple merchants each indicated at 102, a consolidation manager 104, and a shipping manager 106, each coupled to network 108. The network 108 may include, without limitation, one or more local area network (LAN), wide area network (WAN) (e.g., the Internet, etc.), mobile network, virtual network, other network as described herein, and/or other suitable public and/or private networks capable of supporting communication among two or more of the illustrated components, or any combination thereof. In one example, the network 108 includes multiple networks, where different ones of the multiple networks are accessible to different ones of the illustrated components in FIG. 1.

The illustrated system 100 also includes multiple carriers each indicated at 110, and each available to transport one or more products purchased by a consumer 112 from the merchants 102. The carriers 110 may include any delivery service entity, such as UPS®, FedEx®, DHL®, or others in the business of delivering products from one location to another. In this particular embodiment, each of the carriers 110 is distributed geographically across multiple carrier locations 114. When a product is in transit, by the carriers 110, the product is moved through one or more of the carrier locations 114, associated with the particular carrier 110, to its destination. In transit, products may be scanned by the carriers 110, thereby permitting the carriers 110 to substantially track the products from their origin(s) up until the products are delivered to the consumer 112.

Generally in system 100, the merchants 102 offer products for sale, for example, through various websites, while the consumer 112 buys products from the merchants 102. In connection with the purchases, the consumer 112 may desire to consolidate shipment/delivery of multiple different purchases from one or more of the merchants 102 to provide efficiency, economy, and/or convenience, etc. In various embodiments, the consolidation manager 104 routes products associated with the different purchases from the merchants 102 to a hold location 116 of the carrier 110′ (e.g., via the carrier 110′, or one or more of the other carriers 110, etc.). The consolidation manager 104 further holds, collects, etc. these products at the hold location 116, until one or more particular shipping criteria are achieved. At which point, the consolidation manager 104 routes the products to the consumer 112. The shipping manager 106, in turn, directs the consolidated shipment of products, via the carrier 110′, to the consumer 112.

In the illustrated embodiment, the hold location 116 is associated with the carrier 110′ and includes a particular facility associated with the carrier, such as a distribution center. In at least one example, the hold location 116 is a distribution center of the carrier 110′ closest to the consumer 112. However, the hold location 116 may be separate from the carrier 110′, or its carrier locations 114. For example, the hold location 116 may be a location associated with the merchants 102, etc., where products purchased from the particular merchants 102 are then held for the consumer 112 until the one or more particular shipping criteria are achieved.

Also, in the illustrated embodiment, the consolidation manager 104 is separate from the shipping manager 106 and the carriers 110. However, it should be understood the consolidation manager 104 could be implemented in combination with the shipping manager 106 at the carrier 110′ (as indicated by the broken lines in FIG. 1) such that all are then implemented through the carrier 110′.

Further, in some embodiments, it is contemplated that the consolidation manager 104 could be implemented through one or more of the merchants 102 or another entity associated with purchase transactions and/or delivery of the purchased products.

The shipping manager 106, meanwhile, is associated with the particular carrier 110′ and operates to direct products through one or more carrier locations 114 of the carrier 110′ to the consumer 112. In the embodiments herein, products may be routed to a hold location 116 associated with the carrier 110′ for consolidation with other products purchased by the consumer 112 from one or more of the merchants 102. Then, the shipping manager 106 operates to direct (via the carrier 110′) the consolidated shipment of products, at the appropriate time, from the hold location 116 to the consumer 112.

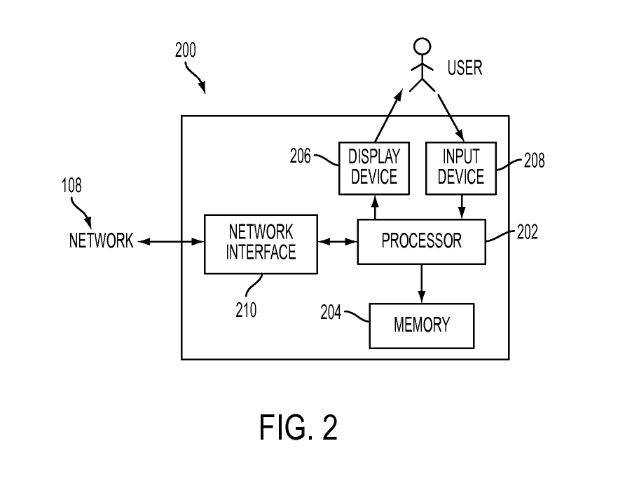

FIG. 2 illustrates an exemplary computing device 200. In the exemplary embodiment of FIG. 1, each of the merchants 102, each of the carriers 110, the consolidation manager 104, the shipping manager 106, and the consumer 112 are illustrated as including computing device 200, coupled to the network 108. The computing device 200 may include, for example, one or more servers, workstations, personal computers, laptops, tablets, PDAs, smartphones, etc. With that said, the system 100, and its components, should not be considered to be limited to the computing device 200, as described below, as different computing devices and/or arrangements of computing devices may be used. In addition, different components and/or arrangements of components may be used in other computing devices. Further, in various exemplary embodiments the computing device 200 may include multiple computing devices located in close proximity, or distributed over a geographic region.

In addition, each computing device 200 included in the system 100 of FIG. 1 may include a single computing device, or multiple computing devices located together or distributed across a geographic region. For example, in various embodiments, the consolidation manager 104 and/or the shipping manager 106, for example, include multiple computing devices located in close proximity, or distributed over a geographic region. Additionally, the carriers 110 may include multiple computing devices distributed geographically, and/or in some embodiments, at least one computing device at each carrier location 114 (and/or at the hold location 116). Further, each computing device 200 may be coupled to a network (e.g., the Internet, an intranet, a private or public LAN, WAN, mobile network, virtual network, or other suitable network, etc.) that is either part of the network 108 (e.g., capable of supporting communication between the computing device 200 and the network 108, etc.), or separate therefrom.

The exemplary computing device 200 includes a processor 202 and a memory 204 that is coupled to the processor 202. The processor 202 may include one or more processing units (e.g., in a multi-core configuration, etc.). The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), solid state devices, and/or hard disks. The memory 204 may be configured to store, without limitation, credit account information for the consumer 112, consolidation account information for the consumer 112, purchase information for products, shipping information for products, etc. Furthermore, in various embodiments, computer-executable instructions may be stored in the memory 204 for execution by the processor 202 to cause the processor 202 to perform one or more of the functions described herein, such that memory 204 is a physical, tangible, and non-transitory computer-readable media. It should be appreciated that memory 204 may include a variety of different memories, each implemented in one or more of the functions or processes described herein.

In the exemplary embodiment, computing device 200 includes a display device 206 that is coupled to the processor 202. Display device 206 outputs to a user by, for example, displaying and/or otherwise outputting information such as, but not limited to, pages, applications, options for shipping products, status of product shipments, and/or any other type of data. For example, display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., graphic user interfaces (GUI), or webpages, etc.) may be displayed at computing device 200, and in particular at display device 206, to initiate and/or complete product purchases, to receive shipping instructions from the consumer 112, to direct shipments of products, to track shipments of products, etc. And often, the computing device 200 will cause the interface to be displayed at the display device 206 of another computing device, including, for example, a server hosting a website having multiple interfaces (e.g., webpages, etc.).

The computing device 200 also includes an input device 208 that receives input from the user, such as the consumer 112 or individuals associated with the merchants 102, the carriers 110, the consolidation manager 104, or the shipping manager 106, etc. The input device 208 is coupled to the processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet, a smartphone, or similar device, behaves as both display device 206 and input device 208.

The illustrated computing device 200 also includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 108. In some exemplary embodiments, the computing device 200 includes the processor 202 and one or more network interfaces incorporated into or with the processor 202.

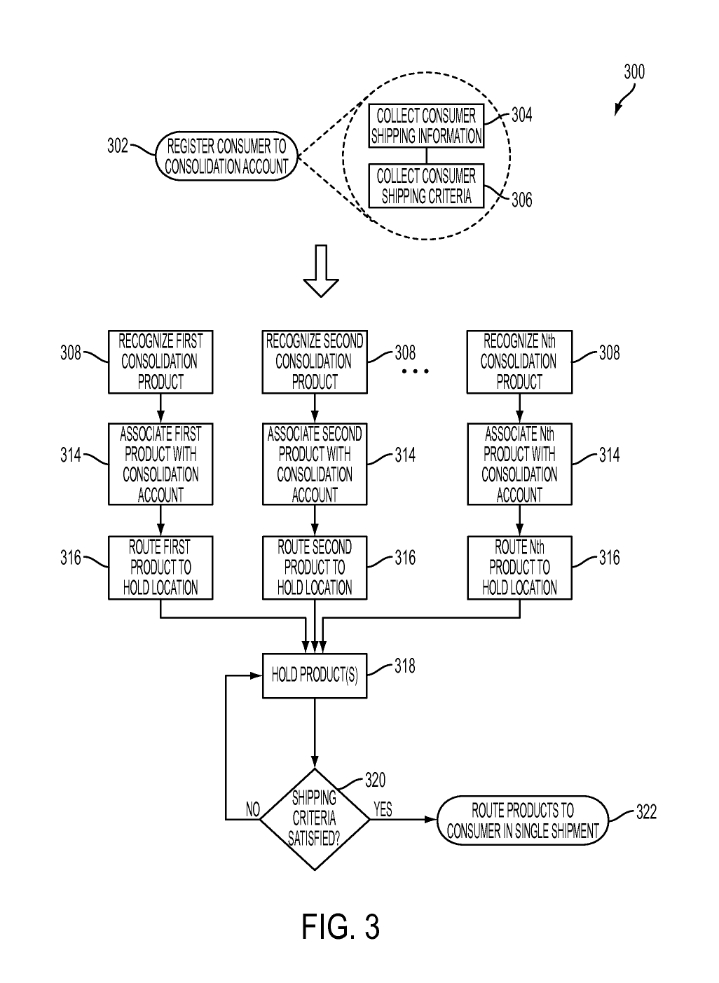

FIG. 3 illustrates an exemplary method, at 300, for consolidating multiple products purchased by the consumer 112 into a single shipment to the consumer 112. The method 300 is generally described with reference to the consolidation manager 104. It should be appreciated, however, that the exemplary method 300 may be implemented in combination with other components of system 100, or in other systems or arrangements of systems. For example, the consolidation manager 104 may be implemented as part of the shipping manager 106 and the carrier 110′; or it may be implemented as part of one or more of the other carriers 110, or as part of one or more of the merchants 102, etc. And, just as the methods herein should not be understood to be limited to the exemplary system 100, or the exemplary computing device 200, the systems and the computing devices herein should not be understood to be limited to the exemplary method 300.

In the illustrated method 300, the consumer 112 is initially registered by the consolidation manager 104 for the product consolidation service, at 302. The registration at 302 may be completed by the consumer 112 in advance of a purchase, or as part of a purchase of a product to be consolidated with other products (e.g., at the time the product is purchased as part of the checkout process, or at the time the product is purchased as a separate registration process, etc.). Registering the consumer 112 may include, for example, creating a consolidation account for the consumer 112, at the computing device 200 associated with the consolidation manager 104. The registration helps provide a means for the consolidation manager 104 to identify products, purchased by the consumer 112, to be consolidated. It also helps the consolidation manager 104 associate and direct various benefits to the consumer 112 for using the product consolidation service. In some aspects, the registration may also be communicated to the merchants 102 to help further ensure that products purchased from the merchants 102, by the consumer 112, are flagged for consolidation.

In at least one example, the consolidation manager 104 may offer a webpage, or other interface, which may be displayed at a computing device 200 to permit the consumer 112 to register. As part of the registration, the consolidation manager 104 may collect (and store in memory 204) general shipping information for the consumer 112, at 304. General shipping information may include any suitable data necessary for contacting the consumer 112, for shipping products to the consumer 112, and for billing the consumer 112. Without limitation, example shipping information may include the consumer's name, the consumer's phone number, the consumer's email address, the consumer's shipping address, the consumer's payment account information, etc. General shipping information may also include a particular or preferred carrier, such as UPS®, FedEx®, DHL®, etc. This can help ensure that the consumer's preferred carrier is used, even when not available as an option at the merchants 102 from whom the consumer 112 may purchase products.

Registering the consumer 112 may further include collecting desired shipping criteria for the consumer 112 at 306. Desired shipping criteria may include any suitable criteria for shipping one or more products from the hold location 116 to the consumer 112. Example shipping criteria includes, without limitation, particular shipment sizes (e.g., 5 pounds, 10 pounds, etc.), particular quantities or counts of products (e.g., 3 products, 5 products, 10 products, etc.), particular days of the week (e.g., every Monday, etc.), particular dates in a month (e.g., the 15th of every month, etc.), particular times/hold periods (e.g., every 15 days, 8 days from receipt, etc.), etc. In some aspects, the consumer 112 may also be able to specify different shipping criteria for different ones of the merchants 102. For example, the consumer may specify that for a particular merchant, deliveries are to be made weekly on Fridays (with other criteria then set for other merchants). It should be appreciated that the consumer 112 may subsequently access his/her consolidation account, via computing device 200 and network 108 (e.g., using a secure web site and consumer login, etc.), and make any updates or changes to the shipping information and/or shipping criteria as desired.

In some embodiments, the shipping criteria set by the consumer 112 during the registration are shared by the consolidation manager 104 with the merchants 102 and/or with the carriers 110. This allows the merchants 102 and the carriers 110 to recognize consumers that are registered for the product consolidation service and, as appropriate, hold purchased products until further instructed/directed by the consolidation manager 104.

At this point, it can be seen that the product consolidation service allows the consumer 112 to specify which carrier is to be used for shipping products (even when not available as an option from the merchants 102), and how and when the products are delivered. This provides the consumer with additional choices/options in shipping the products and, thus, ultimate control of the product deliveries.

In addition, it is contemplated that, through the product consolidation service, different levels of service (e.g., gold, platinum, etc.), rewards, benefits, etc. can be provided to the consumer 112 (by the consolidation manager 104, by the courier 110′, etc.) in connection with shipping the products depending, for example, on how often the consumer utilizes the service and/or on the specified carrier 110′. As an example, the consumer 112 may be elevated to a gold level by the consolidation manager 104 after making a particular number of shipments, or after spending a particular amount of money on shipping, or after shipping a particular weight and/or quantity of products (or after combinations thereof), or after satisfying any other criteria. Then, with this elevation, the consumer may receive discounts on shipments of products or free shipping, or other benefits (e.g., cash rewards, gift cards, etc.) from the consolidation manager 103 and/or carrier 110′. Further, as another benefit, the consumer may be provided special pre-alert notifications of the product deliveries, for example, specific times at which the deliveries will be made, notifications of large or oversize shipments, notifications that more than a certain number of products or deliveries are arriving on a single day, etc.

In some embodiments, the product consolidation service may also provide updates to the consumer 112 (e.g., via email, etc.) regarding shipment status and providing a schedule of future shipments (e.g., scheduled in the upcoming week, month, etc.). In some aspects, the updates may also include a listing of past/completed shipments. In these aspects, the schedule of future shipments and/or listing of past/completed shipments may further include various details of the shipments and/or products associated therewith (e.g., product descriptions, shipment weight, shipment cost, etc.). Such notices may be provided to all consumers registered for the product consolidation service, or to consumers that have achieved a particular level of service (e.g., the gold level, etc.).

With reference again to the method 300 of FIG. 3, an exemplary application of the product consolidation service will be described. The consumer 112 initially purchases one or more products from a merchant 102. For shipment/delivery, the consumer 112 may simply opt to have the product shipped directly to the consumer 112 (without consolidation).

Alternatively, and as shown in the method 300 of FIG. 3, the consumer 112 may opt to use the product consolidation service and have the product consolidated, into a pool of products previously purchased by the consumer 112, or as a first product in a pool of products to be consolidated, etc. Here, the consumer 112 designates the product for consolidated shipment at checkout, or soon thereafter. For example, the consumer 112 may specifically designate the product for consolidated shipment at checkout by, for example, entering a consolidation account number (associated with the consumer's registration at 302), or entering a consolidation shipping address, etc. Or, the consumer 112 may designate the product for consolidated shipment upon selecting the consumer's preferred carrier 110′ at checkout (where the consumer's preferred carrier 110′ is an option provided by the merchant 102, and where the consolidation manager 104 has shared the consumer's registration information for the product consolidation service with the carrier 110′). Here, following such selection, the carrier 110′ may recognize the consumer 112 as being registered for the product consolidation service and flag the product for consolidated shipment (which may also include notifying the merchant 102). Or, the merchant 102 may recognize the consumer 112 at checkout as being registered for the product consolidation service and flag the product for consolidated shipment (where the consolidation manager 104 has shared the consumer's registration information for the product consolidation service with the merchant 102). Or further, the consumer 112 and/or the merchant 102 may directly contact the consolidation manager 104 and identify the purchase at the merchant 102 as involving a product to be included in the product consolidation service. As can be seen, the designation may be directed to the merchant 102, as part of the check-out process, to one of the carriers 110 (directly or through the merchant 102), and/or to the consolidation manager 104.

In one example, the merchant's website provides interaction with the consumer 112, at checkout, to allow the consumer 112 to select a carrier to deliver the purchased product. When the consumer's preferred carrier 110′ is an option, the consumer 112 can select the carrier 110′ through the website. Here, following such selection, the consolidation manager 104 (and, in some cases, the carrier 110′ as well) is notified of the selection by the merchant 102 and, upon recognizing the consumer 112 as being registered for the product consolidation service, flags the product for consolidated shipment (which may also include notifying the merchant 102).

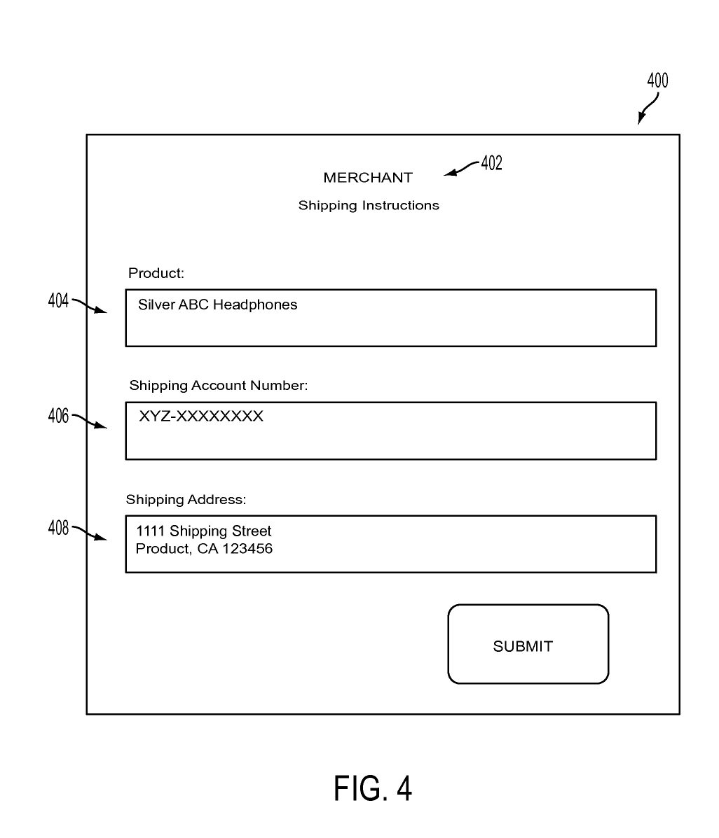

In another example, the merchant's website provides interaction with the consolidation manager 104 or carrier 110, without the consumer 112 being aware, e.g., through an API call, etc. In this or other manners, an interface may be displayed to the consumer's computing device 200, by the consolidation manager 104 or carrier 110, to solicit additional information associated with shipment generally, or with the consolidation request. FIG. 4, for example, illustrates a shipping interface 400 that may be provided by the consolidation manager 104 to solicit shipping instructions for the product. As shown, the exemplary interface 400, which may be displayed by the consolidation manager 104 as a webpage, or part of a webpage, includes a general identification 402 of the merchant 102 from whom the product was purchased, a general description of the purchased product 404, and text boxes 406, 408 for providing a shipping account number for the consumer 112 (e.g., an account number associated with the consumer's consolidation account, etc.) and/or a shipping address for the consumer 112.

It should be appreciated that interface 400 is merely exemplary, and that a variety of other interfaces may be provided by the consolidation manager 104, or other entities, to direct shipment of the product. In another example, an interface includes a check-box for consolidation of the product for shipment, and a field to enter a particular carrier. In still other examples, interfaces may additionally, or alternatively, include options to enter payment information, options to directly requesting consolidation of the current purchase with other purchases made by the consumer 112, options to select particular carriers 110 to be used for shipping the product, or in several examples, options to enter particular shipping criteria for the product (e.g., as exceptions to the desired shipping criteria for the consumer's consolidation account, etc.), etc. As can be seen, various different interfaces may be used to solicit, from the consumer 112, shipment information, generally or to consolidate shipment of products while having a variety of different arrangements, formats and/or options to display, describe, provide or request desired information.

Referring again to FIG. 3, after the product is purchased by the consumer 112 (and designated for consolidated shipment), the product is picked-up by one of the carriers 110, or delivered to one of the carriers 110. The particular carrier 110 may be selected by the consumer 112, and may or may not include the consumer's preferred carrier 110′.

Once the product is in the possession of the carrier 110, or before that through interaction with the merchant 102, the consolidation manager 104 recognizes the designated product as a consolidation product at 308. The recognition 308 may coordinate with the designation of the product as a consolidation product, as described above, such that the consolidation manager 104 recognizes the product as a consolidation product once it is designated as such (e.g., at checkout, shortly thereafter, etc.). For example, and as generally described above, the recognition 308 may include the carrier 110 identifying the delivery address of the product as a hold location 116 of the carrier 110′. In such an example, the carrier 110′ recognizes the product as a consolidation product at receipt of the product from the merchant 102, based on a tracking number or other indicia associated with the product. Additionally, or alternatively, the consolidation manager 104 may recognize the product as a consolidation product based on its involvement in the check-out of the product (e.g., based on selection of the preferred carrier 110′ by the consumer 112 at check-out and subsequent flagging of the product by the carrier 110′; identification of the consumer 112 by the consolidation manager 104, merchant 102, or carrier 110′ at checkout; etc.). In still other examples (and again as described above), the consolidation manager 104 may be notified of the product by the merchant 102 or the consumer 112. Here, the notification may include, for example, an email, which may include the identity of the merchant 102, a purchase order number for the product, a confirmation number for the product, a tracking number for the product, or other information that the consolidation manger 104 may use to identify the product, the merchant 102, and/or the carrier 110 in possession of the product.

It should be appreciated that the consolidation manager 104 may recognize different products as consolidation products in different ways (and generally following, and generally coordinated with, designation of the product as a consolidation product). For example, some products may be recognized at check-out where the consolidation manager 104 cooperates with the merchant 102, while other products may be recognized by the courier 110 either before or after the courier 110 is in possession of the product, and while still other products may be recognized by the consolidation manager 104 in response to a notification from the consumer 112.

In any case, after designating and recognizing the product as a consolidation product, or contemporaneously therewith, the consolidation manager 104 associates the product with a consolidation account of the consumer 112 at 314. The association may be accomplished by, for example, matching indicia on the product to the consolidation account, etc. Once associated with the consolidation account, the consolidation manager 104 may then further use, in this example, general shipping information of the consumer 112 and one or more of the consumer's shipping criteria, described above, in further operations described below. And, the consolidation manager 104 may then communicate a notification (e.g., an email or text message, etc.) to the consumer 112 indicating that the product is being consolidated and identifying the criteria under which the product will ultimately be shipped. In some aspects, the communication may also include an option for the consumer 112 to accept or modify the shipping criteria.

The consolidation manager 104 then routes the product to the hold location 116, at 316, via one of the carriers 110. In some aspects, the carrier 110 transports the product through one or more carrier locations 114 to the hold location 116. The hold location 116 may be determined by the consolidation manager 104, based on the consumer's consolidation account, an address, or the consumer 112, and/or other factors that may affect efficient delivery of one or more products to the consumer 112. The hold location 116, in this example, is associated with carrier 110′. As such, where a different one of the carriers 110 is an initial carrier for the product, the initial carrier may deliver the product to the carrier 110′ at the hold location 116, or another location. Regardless of the particular carrier 100, the product, and other products for shipment to the consumer 112, are consolidated to the hold location 116 (where they are collected). As described above, in some embodiments, the hold location 116 may alternatively be at the merchant 102 from which the product was purchased (instead of with the carrier 110′).

Once consolidated, the consolidation manager 104 holds (and collects) the products at 318 until at least one shipping criteria is satisfied. In particular, the consolidation manager 104 continually evaluates the consumer's shipping criteria, at 320, to determine if the products should be further held or shipped. The basis for such evaluation includes the shipping criteria associated with the consumer's consolidation account, whether based on general instructions or instructions entered by the consumer 112 at checkout for the particular product. Once the shipping criteria are satisfied, the consolidation manager 104 routes the product to the consumer 112, by providing shipping instructions, via the network 108, to the shipping manager 106. In turn, the carrier 110′ is directed, by the shipping manager 106, to deliver the consolidated products to the consumer 112 at 322. The delivery may be routed by the consolidation manager 104 and/or directed by the shipping manager 106 consistent with the instructions included in the consolidation account. Instructions may include, for example, time and date of delivery. In at least one embodiment, the shipping instruction may be indicated by the shipping criteria (e.g., hold product until 10:00 pm on Tuesdays, then ship, etc.).

Either before or after the consolidated products are ultimately routed to the consumer 112, at 322, the consolidation manager 104 may evaluate the consumer's account and direct one or more discount (or other benefit) to the consumer 112, in connection with billing the consumer 112 for delivering the products. For example, the consolidation manager 104 may bill the consumer 112 for delivering the products through a payment account linked to the consolidation account created during registration. As part of the bill, the consolidation manager may provide a discount to the consumer 112 (e.g., in the form of a reduced bill, etc.) depending, for example, on the level of service attained by the consumer 112 with the consolidation manager 104 and/or carrier 110′.

In this manner, the carrier's individual shipments from the hold location 116 to the consumer 112 may be reduced, from deliveries for each of the multiple products from multiple transactions to a single delivery. In addition, the consumer's use of the consolidation account, favoring a common carrier (e.g., carrier 110′, etc.) associated with the consolidation manager 104, causes the consumer 112 to direct his/her purchased products through the common carrier. Further, by allowing the consumer 112 to consolidate products and use selected carriers, the consumer 112 can be empowered to negotiate shipping deals and benefit rewards with the carriers for repeat use. Thus, the methods and systems described herein can provide reduced shipping costs, through a reduced number of total delivers and/or repeated use of the common carrier. Moreover, as can now be appreciated, by specifying how and when the products are delivered to the consumer 112, the consumer gains power to control shipping and convenience in receiving the consolidated products in a single shipment, as compared to multiple shipments spread out over different times.

In some embodiments, the computing device 200 associated with the consumer 112 includes a mobile computing device with an application for use in consolidating shipments of products from the merchants 102 to the consumer 112 (e.g., in accordance with the system 100, the method 300, etc.). The memory 204 of the computing device 200, and specifically, the non-transitory computer readable media, may include computer-executable instructions that when executed by the processor 202 cause the processor 202 to process consolidation requests from the consumer 112, to cause notifications relating to consolidated shipments to be displayed, and/or to perform other functions described herein, etc. For example, using the application, which may communicate with the computing device 200 of the consolidation manager 104 via any available communication type (e.g., email, text message, etc.), the consumer 112 may view notifications regarding shipment of products, pay invoices for shipment of the products (e.g., via payment accounts, etc.), etc.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) registering, at a server, a consumer to a consolidation account for consolidated shipping of products to the consumer, the consolidation account including at least one predefined shipping criteria, (b) associating, at the server, a first product purchased by the consumer from a first merchant with the consolidation account, (c) associating, at the server, a second product purchased by the consumer from a second merchant with the consolidation account, (d) routing, by the server, the first and second products to a hold location, and (e) routing, by the server, at least the first and second products, as a single shipment, to the consumer, when the at least one predefined shipping criteria is achieved.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” or “included with” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for consolidating a shipment, by a carrier, of purchased products to a consumer, the method comprising:
registering a consumer to a consolidation account for consolidated shipping of products to the consumer, the consolidation account including at least one shipping criteria;
associating, at a computing device, a first product purchased by the consumer in a first transaction with the consolidation account;
associating, at the computing device, a second product purchased by the consumer in a second transaction with the consolidation account;
routing the first and second products to a hold location; and
routing, by the computing device, at least the first and second products, as a single consolidated shipment, to the consumer, when the at least one shipping criteria is achieved.

2. The method of claim 1, wherein associating the first product with the consolidation account includes receiving a notification from the consumer.

3. The method of claim 1, wherein associating the first product with the consolidation account includes receiving a notification from a merchant of the first product.

4. The method of claim 1, wherein associating the first product with the consolidation account includes receiving the first product at a location, prior to routing the first product to the hold location, and matching indicia on the product with the consolidation account.

5. The method of claim 1, further comprising collecting the first product from a merchant of the first product.

6. The method of claim 1, wherein the at least one shipping criteria includes a particular product count.

7. The method of claim 1, wherein the at least one shipping criteria is selected from the group consisting of: a particular date, a particular hold period, and a particular shipment size.

8. The method of claim 1, further comprising receiving, at the computing device, a change in the at least one shipping criteria.

9. The method of claim 1, wherein the first transaction involves a first merchant, and the second transaction involves a second merchant different than the first merchant.

10. The method of claim 1, wherein the first and second products are purchased by the consumer from the same merchant on different dates.

11. The method of claim 1, further comprising directing at least one benefit to the consumer in connection with the consolidated shipment.

12. A system for shipping multiple products, purchased from different merchants or purchased from the same merchant at different times, to a consumer, the system comprising:
a memory configured to store data associated with a consolidation account registered to a consumer, including at least one predefined shipping criteria; and
a processor configured to:
associate products purchased by the consumer with the consolidation account;
route the products to a hold location, for consolidation of the products into a single shipment; and
route the products, as the single shipment, to the consumer, when the at least one predefined shipping criteria is achieved.

13. The system of claim 12, wherein the data stored in the memory further includes a preferred carrier for transporting the single shipment to the consumer.

14. The system of claim 12, wherein the processor is further configured to receive a consolidation notification from one or more of the consumer and a merchant of at least one of the products.

15. The system of claim 12, wherein the at least one predefined shipping criteria includes a particular product count.

16. The system of claim 12, wherein the at least one predefined shipping criteria is selected from the group consisting of a particular date, a particular hold period, and a particular shipment size.

17. The system of claim 12, wherein the first product is purchased by the consumer from a first merchant, and the second product is purchased by the consumer from a second merchant.

18. The system of claim 12, wherein the first and second products are purchased by the consumer from the same merchants on different dates.

19. A non-transitory computer readable media comprising instructions that, when executed by at least one processor, cause the at least one processor to:
generate a consolidation account for a consumer for use in consolidating shipments of products to the consumer, the consolidation account including at least one shipping criteria;
associate products purchased by the consumer with the consolidation account;
collect the products at a hold location; and
route the collected products, as a single consolidated shipment, to the consumer, when the at least one shipping criteria is achieved.

20. The non-statutory computer readable media of claim 19, wherein instructions are further configured to cause the at least one processor to direct at least one benefit to the consumer in connection with the consolidated shipment.
